(19) United States
(12) Patent Application Publication
(10) Pub. No.: US 2026/0018038 A1
(43) Pub. Date: Jan. 15, 2026

(54) AIR INTAKE TYPE SMOKE DETECTOR

(71) Applicant: ELECTRONICS AND TELECOMMUNICATIONS RESEARCH INSTITUTE, Daejeon (KR)

(72) Inventors: SOOCHEOL KIM, Daejeon (KR); Hoe-Sung Yang, Daejeon (KR); Kang Bok Lee, Daejeon (KR); Kwang-Soo Cho, Daejeon (KR); Jin Hwa Ryu, Daejeon (KR); Yusun Ahn, Daejeon (KR); Kyu Won Han, Daejeon (KR)

(21) Appl. No.: 19/265,899

(22) Filed: Jul. 10, 2025

(30) Foreign Application Priority Data
Jul. 12, 2024 (KR) 10-2024-0092491
Jun. 30, 2025 (KR) 10-2025-0086948

(51) Int. Cl. G08B 17/107; G01N 21/53

(52) U.S. Cl. CPC G08B 17/107; G01N 21/532

(57) ABSTRACT

Disclosed is an air intake type smoke detector. The air intake type smoke detector performs an operation of radiating light to inhaled smoke particles by using a light-emitting element, obtaining a transmissive signal and a scattering signal as the results of the radiation of the light to the smoke particles by using a light-receiving element, calculating the absorption coefficient and scattering coefficient of the smoke particles based on the transmissive signal and the scattering signal, determining a cause substance of the smoke particles and the presence or absence of fire based on the absorption coefficient and the scattering coefficient, and notifying the outside of the results of the determination.

### CROSS-REFERENCE TO RELATED APPLICATIONS

This application claims priority under 35 U.S.C. § 119 to Korean Patent Application Nos. 10-2024-0092491, filed on Jul. 12, 2024, and 10-2025-0086948, Jun. 30, 2025, the disclosure of which is incorporated herein by reference in its entirety.

### BACKGROUND

### 1. Technical Field

The present disclosure relates to an air intake type smoke detector and to an apparatus for obtaining a light signal through a light-receiving element by radiating multiple light sources to inhaled smoke and determining even the type of fire or a non-fire factor in addition to the presence or absence of fire by analyzing the light signal, and an operating method of the same.

### 2. Related Art

A common air intake type smoke detector has a structure in which the air intake type smoke detector inhales smoke through a pipe and detects the smoke introduced into a chamber by using a light-emitting element and a light-receiving element. However, such a smoke detector is used only in a closed space or a limited environment because the smoke detector reacts to even smoke particles, such as cooking smoke, fine dust, water vapor, or yellow dust that are non-fire factors, in addition to smoke attributable to fire. Furthermore, the smoke detector can detect only the presence or absence of fire, and rarely identify the type of fire (e.g., common, oil, electricity, or metal) or a non-fire factor.

Among prior arts of the present disclosure, there was disclosed an air sampling detection type fire detection system (Korean Patent No. KR10-2624131) having a function for analyzing smoke particles. The fire detection system radiates infrared rays of an LED to smoke in order to identify particle characteristics and analyzes smoke particles by detecting a signal through an infrared sensor and an image sensor for sensing an image of particles. However, the publication does not describe a detailed smoke particle analysis method. Furthermore, the fire detection system has difficulties in identifying a non-fire factor based on only the size of particles simply.

### SUMMARY

Various embodiments are directed to providing an air intake type smoke detector which can calculate an absorption coefficient, a scattering coefficient, and a smoke concentration, that is, optical properties of smoke, and the ratio of a molecular absorption coefficient and a molecular scattering coefficient, that is, intrinsic properties of a material, based on a transmissive light signal and a scattering light signal, and can identify a non-fire factor (e.g., cooking smoke, fine dust, water vapor, or yellow dust) in addition to the type of fire (e.g., common, oil, electricity, or metal) based on the ratio, and an operating method thereof.

Objects of the present disclosure are not limited to the aforementioned object, and other objects not described above may be evidently understood by those skilled in the art from the following description.

An operating method of an air intake type smoke detector according to an embodiment of the present disclosure is a method performed by the air intake type smoke detector.

The operating method includes radiating light to smoke particles inhaled into air intake type smoke detector by using a light-emitting element, obtaining a transmissive signal and a scattering 1 as the results of the radiation of the light to the smoke particles by using a light-receiving element, calculating the absorption coefficient and scattering coefficient of the smoke particles based on the transmissive signal and the scattering signal, performing a determination of the cause substance of the smoke particles and the presence or absence of fire based on the absorption coefficient and the scattering coefficient, and notifying the outside of the results of the determination through at least one means including the transmission of information to a user terminal, a display, and a speaker.

An air intake type smoke detector according to an embodiment of the present disclosure includes a light-emitting unit including a light-emitting element and configured to radiate light to inhaled smoke particles, a light-receiving unit including a light-receiving element and configured to obtain a transmissive signal and a scattering signal as the results of the radiation of the light to the smoke particles by using the light-receiving element, and a signal processing unit including a processor and memory in which one or more instructions executed by the processor are stored.

The one or more instructions include an instruction to calculate the absorption coefficient and scattering coefficient of the smoke particles based on the transmissive signal and the scattering signal, an instruction to perform a determination of the cause substance of the smoke particles and the presence or absence of fire based on the absorption coefficient and the scattering coefficient, and an instruction to notify the outside of the results of the determination through at least one means including the transmission of information to a user terminal, a display, and a speaker.

The air intake type smoke detector proposed in an embodiment of the present disclosure can detect smoke by calculating a scattering coefficient and an absorption coefficient in addition to a smoke concentration and analyzing the ratio of a molecular scattering coefficient and a molecular absorption coefficient, that is, intrinsic properties of a material, can determine the presence or absence of fire with high accuracy and excellent reliability, and identify the type of fire or a non-fire factor.

Furthermore, the air intake type smoke detector proposed in an embodiment of the present disclosure has excellent price competitiveness because the air intake type smoke detector can have a small structure with low-cost components and is very advantageous even in product commercialization because the air intake type smoke detector can easily operate in conjunction with the pipeline of the existing air intake type detection system.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a construction diagram of an air intake type smoke detection system according to an embodiment of the present disclosure.

FIG. 2 is a block diagram illustrating a construction of an air intake type smoke detector according to an embodiment of the present disclosure.

FIG. 3 is a diagram illustrating a construction of the air intake type smoke detector according to an embodiment of the present disclosure.

FIG. 4 is a diagram illustrating a construction of the light-emitting unit and light-receiving unit of the air intake type smoke detector according to an embodiment of the present disclosure.

FIG. 5 is a flowchart for describing an operating method of the air intake type smoke detector according to an embodiment of the present disclosure.

FIG. 6 is a cumulative scatter plot in which absorption coefficients and scattering coefficients according to smoke concentrations for each smoke type are indicated.

FIG. 7 is a diagram illustrating the ratio of a molecular absorption coefficient and a molecular scattering coefficient for each smoke type.

### DETAILED DESCRIPTION

An embodiment of the present disclosure relates to an air smoke detector. Specifically, an intake type embodiment of the present disclosure relates to an air intake type smoke detector which obtains a light signal that is scattered or transmitted by radiating multiple light sources to smoke inhaled into a pipe and identify a fire factor or a non-fire factor by calculating an absorption coefficient, a scattering coefficient, a smoke concentration, and the ratio of a molecular absorption coefficient and a molecular scattering coefficient, and an operating method thereof.

Advantages and characteristics of the present disclosure and a method for achieving the advantages and characteristics will become apparent from embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains to the category of the present disclosure. The present disclosure is merely defined by the category of the claims. Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Terms, such as a first and a second, may be used to describe various components, but the components should not be restricted by the terms. The terms may be used to only distinguish one component from the other components. Accordingly, a first component may be named a second component without departing from the scope of a right of the present disclosure. Likewise, a second component may also be named a first component.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components. Other expressions for describing relations between components, that is, “between ˜”, “just between ˜”, “adjacent to ˜”, and “neighboring ˜”, should be likewise construed.

In describing the present disclosure, a detailed description of a related known technology will be omitted if it is deemed to make the subject matter of the present disclosure unnecessarily vague.

Hereinafter, embodiments of the present disclosure are described in detail with reference to the accompanying drawings. In describing the present disclosure, in order to facilitate general understanding of the present disclosure, the same reference numeral is used for the same mean regardless of the reference numeral.

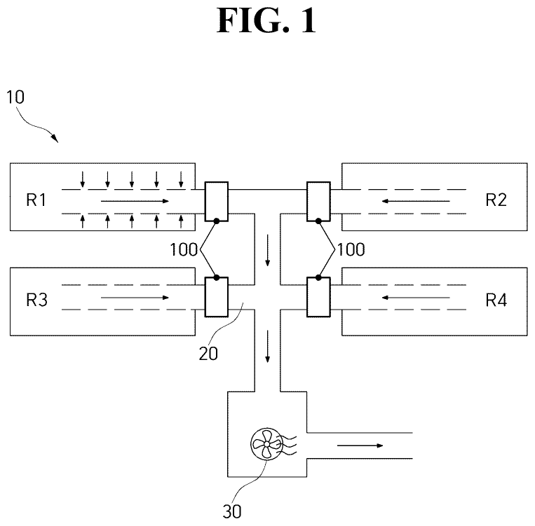

FIG. 1 is a construction diagram of an air intake type smoke detection system according to an embodiment of the present disclosure. An air intake type smoke detection system 10 includes a pipeline 20 through which the air is inhaled and moved, an air intake type smoke detector 100 (hereinafter referred to as a “smoke detector”) that detects smoke particles included in the air, and an exhaust fan 30 that discharges the inhaled air to the outside.

In each of independent spaces R1, R2, R3, and R4, smoke particles are inhaled by the air intake type smoke detection system 10 along the pipeline 20 and pass through the smoke detectors 100 installed in the pipeline 20. The air intake type smoke detection system 10 may determine whether fire has occurred (i.e., the presence or absence of fire), a location where fire has occurred (e.g., any one of the spaces R1, R2, R3, and R4), and the type of fire or a non-fire factor based on a signal (e.g., the transmissive signal of light and the scattering signal of light) obtained by the smoke detector 100 or the results of a determination of the air intake type smoke detector 100. For example, the air intake type smoke detection system 10 may identify the type of fire (e.g., common, oil, electricity, or metal) or identify a non-fire factor (e.g., cooking smoke, fine dust, water vapor, or yellow dust).

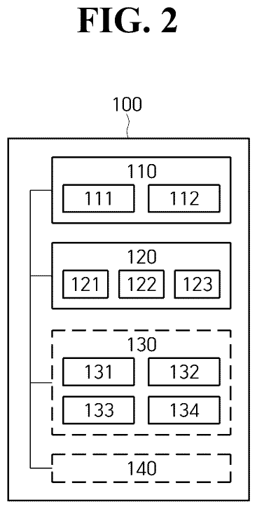

FIG. 2 is a block diagram illustrating a construction of the smoke detector according to an embodiment of the present disclosure.

Referring to FIG. 2, the smoke detector 100 according to an embodiment of the present disclosure includes a light-emitting unit 110, a light-receiving unit 120, a signal processing unit 130, and a communication device 140.

The smoke detector 100 illustrated in FIG. 2 is an embodiment. The components of the smoke detector 100 according to an embodiment of the present disclosure are not limited to the embodiment illustrated in FIG. 2, and a component may be added, changed, or deleted, if necessary. For example, the smoke detector 100 may include the light-emitting unit 110 and the light-receiving unit 120 without the signal processing unit 130 and the communication device 140. In this case, the air intake type smoke detection system 10 may determine the presence or absence of fire and a cause substance of smoke particles by processing a transmissive signal and a scattering signal generated by the light-receiving unit 120 by using an amplifier, an analog-digital converter (ADC), and a processor, and may transmit the results of the determination of the presence or absence of fire and the cause substance to the outside by using a separate communication device or may display the results of the determination of the presence or absence of fire and the cause substance through an output interface device or acoustically provide notification of the results of the determination of the presence or absence of fire and the cause substance.

Referring to FIG. 2, the light-emitting unit 110 includes one or more light-emitting elements 111 and a lens 112. The light-emitting element 111 may be a one-dimensional (1-d) or two-dimensional (2-D) light source array including an LED or a laser diode. The light source array may include any one of a plurality of light sources (e.g., LEDs or laser diodes) having the same wavelength and a plurality of light sources having different wavelengths. The light-emitting element 111 radiates light to smoke particles inhaled through the lens 112.

Furthermore, referring to FIG. 2, the light-receiving unit 120 includes one or more first light-receiving elements 121, one or more second light-receiving elements 122, and cover glass 123 that protects the first light-receiving elements 121 and the second light-receiving elements 122. The first light-receiving element 121 is a light-receiving element for light absorption measurement. The second light-receiving element 122 is a light-receiving element for light scattering measurement. That is, the first light-receiving element 121 generates a transmissive signal having a current or a voltage by measuring a light signal that passes through smoke particles. The second light-receiving element 122 generates a scattering signal having a current or a voltage by measuring a light signal scattered by the smoke particles. That is, the light-receiving unit 120 obtains the transmissive signal and the scattering signal as the results of the radiation of the light to the smoke particles by the light-emitting element 111 by using the first light-receiving element 121 and the second light-receiving element 122.

Furthermore, referring to FIG. 2, the signal processing unit 130 includes an amplifier 131, an analog-to-digital converter (ADC) 132, a processor 133, and memory 134. The amplifier 131 amplifies an analog transmissive signal and an analog scattering signal. The ADC 132 converts the amplified transmissive signal and the amplified scattering signal into digital signals. Furthermore, the processor 133 determines the presence or absence of fire and a cause substance (e.g., the type of fire or a non-fire factor) of smoke particles based on the transmissive signal and the scattering signal converted into digital signals, and transmits the results of the determination to the air intake type smoke detection system 10, a user terminal, or an external server through the communication device 140.

For example, the components 131, 132, 133, and 134 of the signal processing unit 130 may be included in the air intake type smoke detection system 10 or an external device.

Furthermore, the processor 133 may be a central processing unit (CPU), or may be a semiconductor device that executes a computer-readable instruction stored in the memory 134. The processor 133 may display information on the presence or absence of fire and a cause substance of smoke particles or acoustically output the information through the smoke detector 100 or a separate output interface device that is included in the air intake type smoke detection system 10 or present on the outside.

The memory 134 may include various types of volatile or non-volatile storage media. For example, the memory 134 may include read only memory (ROM) and random access memory (RAM). In an embodiment of the present disclosure, the memory 134 may be located inside or outside the processor 133. The memory 134 may be connected to the processor 133 through various already known means.

The memory 134 stores one or more instructions that are executed by the processor 133.

The one or more instructions include an instruction to calculate the absorption coefficient and scattering coefficient of smoke particles based on a transmissive signal and scattering signal obtained by the light-receiving unit 120, an instruction to perform a determination of the cause substance of the smoke particles and the presence or absence of fire based on the absorption coefficient and the scattering coefficient, an instruction to notify the outside of the results of the determination through at least one means including the transmission of information to a user terminal, a display, and a speaker.

The instruction to calculate the absorption coefficient and the scattering coefficient may include an instruction to calculate the collimated transmittance of light based on the transmissive signal, an instruction to calculate the total transmittance of the light based on the transmissive signal and the scattering signal, an instruction to calculate the scattering coefficient based on the collimated transmittance, the total transmittance, and the transmission distance of the light, and an instruction to calculate the absorption coefficient based on the collimated transmittance, the transmission distance, and the scattering coefficient.

The instruction to perform the determination may include an instruction to calculate the ratio of the absorption coefficient and the scattering coefficient and to determine the cause substance based on the ratio and an instruction to determine the presence or absence of fire based on the cause substance.

Furthermore, the communication device 140 may transmit or receive a wired signal or a wireless signal to or from the air intake type smoke detection system 10, an external server, or a user terminal.

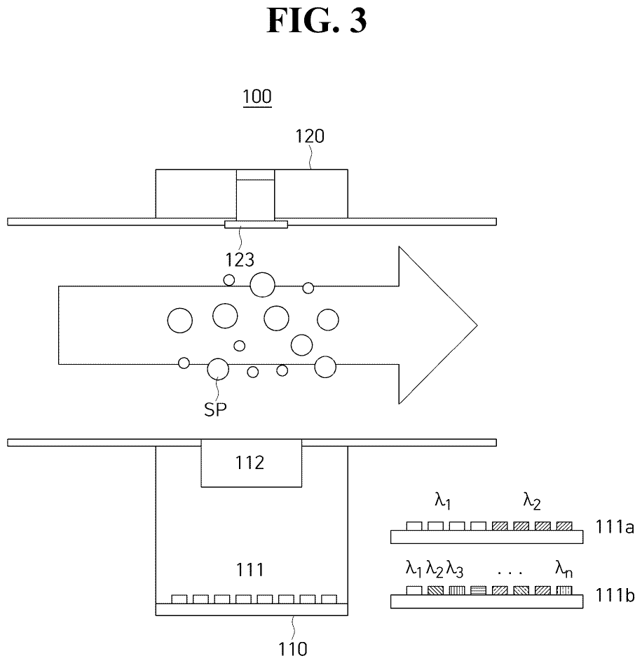

FIG. 3 is a diagram illustrating a construction of the air intake type smoke detector according to an embodiment of the present disclosure.

The smoke detector 100 has a structure which may be applied to the air intake type detection system 10 including the pipeline 20. As described above, the smoke detector 100 includes the light-emitting unit 110 and the light-receiving unit 120. The light-emitting element 111 included in the light-emitting unit 110 may include a 1-D or 2-D light source array. Light that is emitted from the light source of the light-emitting element 111 becomes parallel through the lens 112, and radiates smoke particles SP. Light that is scattered by the smoke particles SP or that passes through the smoke particles SP is measured by the light-receiving unit 120. The cover glass 123 protects the light-receiving unit 120 against the smoke particles SP.

If the light-emitting element 111 is a light source array, the light source array may include LEDs or laser diodes having the same wavelength or different wavelengths. As illustrated in FIG. 3, a light source array 111a, that is, an example of the light-emitting element 111, is a light source array including a plurality of light sources having a wavelength Mi and a plurality of light sources having a wavelength of Az. The light source array 111b is a light source array including a plurality of light sources having wavelengths from Mi to An.

The light-receiving element 121 or 122 of the light-receiving unit 120 may include a light detector or a spectroscope. If a light source array including light sources having different wavelengths is used as the light-emitting element 111 and a spectroscope is used as the light-receiving element 121 or 122 of the light-receiving unit 120, the smoke detector 100 may obtain a signal (i.e., a transmissive signal) that is generated due to light passing through smoke particles and a signal (i.e., a scattering signal) generated due to light scattered by the smoke particles at a time by simultaneously radiating light of all of the light source to smoke.

Furthermore, if a light detector is used as the light-receiving element 121 or 122 of the light-receiving unit 120, the smoke detector 100 may obtain a transmissive signal and a scattering signal in a way to sequentially turn on/off each of the light sources of a light source array, that is, the light-emitting element 111 or modulating light of the light sources into different frequencies and radiating light to smoke particles.

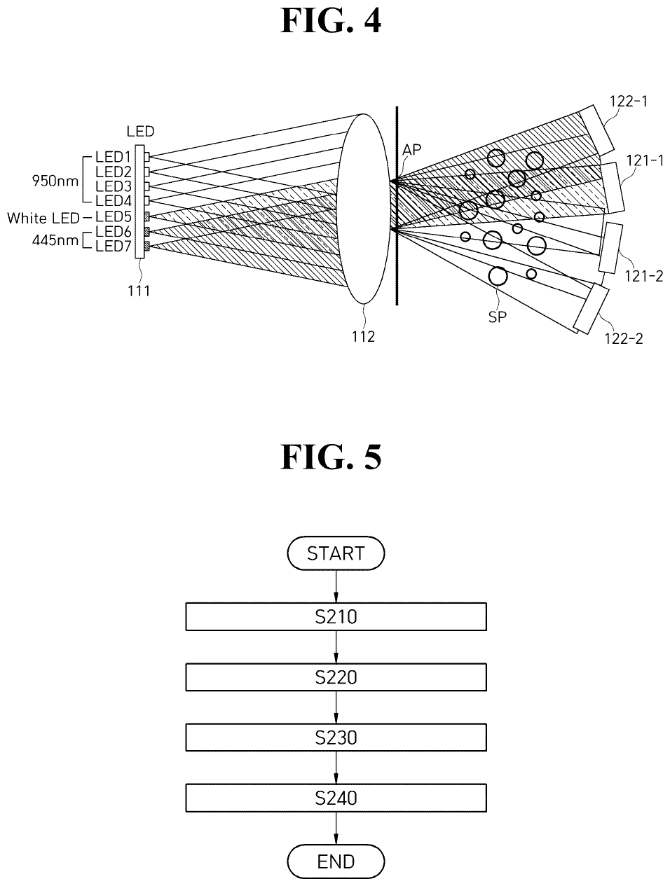

FIG. 4 is a diagram illustrating a construction of the light-emitting unit and light-receiving unit of the air intake type smoke detector according to an embodiment of the present disclosure.

In FIG. 4, the light-emitting element 111 includes a plurality of LED light source arrays having the same wavelength. Light that is output from each of the light sources of the light-emitting element 111 is radiated toward smoke particles SP through the lens 112 and an aperture (AP). The light-receiving unit 120 obtains a transmissive signal through the first light-receiving element 121, and obtains a scattering signal through the second light-receiving element 122. As illustrated in FIG. 4, the first light-receiving element 121 may include a light-receiving element 121-1 that measures light absorption (or a transmissive signal) of a visible ray and a light-receiving element 121-2 that measures light absorption (or a transmissive signal) of near infrared rays. The second light-receiving element 122 may include a light-receiving element 122-1 that measures light scattering (or a scattering signal) of a visible ray and a light-receiving element 122-2 that measures light scattering (or a scattering signal) of near infrared rays.

The embodiment presented in FIG. 4 is only an example. Therefore, various embodiments that modify the embodiment of FIG. 4 may exist. For example, an embodiment may be implemented in which the light-receiving unit 120 includes only one light-receiving element, and the light-receiving element measures both a transmissive signal and a scattering signal. In addition, the light-receiving unit 120 may include a plurality of light-receiving elements that can measure both a transmissive signal and a scattering signal.

FIG. 5 is a flowchart for describing an operating method of the air intake type smoke detector according to an embodiment of the present disclosure.

Referring to FIG. 5, the operating method of the air intake type smoke detector 100 according to an embodiment of the present disclosure includes steps S210 to S240. The operating method illustrated in FIG. 5 is an embodiment. The steps of the operating method according to an embodiment of the present disclosure are not limited to the embodiment illustrated in FIG. 5, and a step may be added, changed, or deleted, if necessary.

Step S210 is a step of obtaining a transmissive signal and a scattering signal by radiating light to smoke particles.

The smoke detector 100 radiates light to smoke particles inhaled into the smoke detector 100 by using the light-emitting element 111. Furthermore, the smoke detector 100 obtains a transmissive signal and a scattering signal as the results of the radiation of the light to the smoke particles by using the light-receiving element 121 or 122 of the light-receiving unit 120. That is, the light-receiving unit 120 obtains the transmissive signal, that is, a signal obtained after the light output by the light-emitting element 111 passes through the smoke particles, and the scattering signal, that is, a signal of the light scattered by the smoke particles. The transmissive signal and the scattering signal may each be a current signal or a voltage signal.

The light-emitting element 111 may be a 1-D or 2-D light source array. Furthermore, the light-emitting element 111 may include any one of a plurality of light sources having the same wavelength and a plurality of light sources having different wavelengths. For example, an LED or a laser diode may be used as the light source of the light-emitting element 111.

The light-receiving element of the light-receiving unit 120 includes the first light-receiving element 121, that is, a light-receiving element for light absorption measurement, and the second light-receiving element 122, that is, a light-receiving element for light scattering measurement. For example, a light detector or a spectroscope may be used as the light-receiving element of the light-receiving unit 120.

Step S220 is a step of calculating the absorption coefficient and scattering coefficient of the smoke particles.

The processor 133 of the signal processing unit 130 calculates the absorption coefficient (uₐ) and scattering coefficient (uₛ) of the smoke particles based on the transmissive signal and scattering signal obtained by the light-receiving unit 120.

Specifically, the processor 133 calculates collimated transmission or collimated transmittance (CT) of the light based on the transmissive signal. For reference, the collimated transmittance CT is a value obtained by dividing the intensity of light that straightly passes through a medium (in this case, the air including the smoke particles) by the intensity of incident light.

Furthermore, the processor 133 calculates total transmittance or total transmission (TT) of the light based on the transmissive signal and the scattering signal. For reference, the total transmittance TT is a value obtained by dividing the intensities of all of light (i.e., straightforward light and scattered light) passing through the medium by the intensity of incident light.

Furthermore, the processor 133 calculates the scattering coefficient (uₛ) of the smoke particles based on the collimated transmittance CT, the total transmittance TT, and the transmission distance (d) of the light. An equation that calculates the scattering coefficient (uₛ) is described later. The transmission distance (d) of the light is a value determined by the design of the smoke detector 100, and is a known value.

Furthermore, the processor 133 calculates the absorption coefficient (uₐ) of the smoke particles based on the collimated transmittance CT, the transmission distance (d), and the scattering coefficient (uₛ). An equation that calculates the absorption coefficient (uₐ) is described later.

In this step, the processor 133 may calculate the obscuration (OBS) of the light based on the collimated transmittance CT and the transmission distance (d). The OBS may be expressed as in Equation 1. The OBS is calculated based on the collimated transmittance CT and the set transmission distance (d) measured by the smoke detector 100.

$$OBS ( 1 - {CT}^{1 / d} ) \qquad ( 1 )$$

Furthermore, the processor 133 may calculate the scattering coefficient (uₛ) by using Equation 2. As described above, the processor 133 may calculate the scattering coefficient (uₛ) based on the collimated transmittance CT, the total transmittance TT, and the transmission distance (d). In Equation 2, E(uₐ, uₛ, <d>) is an error term, and depends on the average of the absorption coefficient (uₐ), the scattering coefficient (uₛ), and the transmission distance (d).

$${μ}_{s} = \frac{ln ( \frac{TT}{CT} ) + E ( {μ}_{a} , {μ}_{s} , 〈 d 〉 )}{d} \qquad ( 2 )$$

Furthermore, the processor 133 may calculate the absorption coefficient (uₐ) by using Equation 3. As described above, the processor 133 may calculate the absorption coefficient (uₐ) based on the collimated transmittance CT, the transmission distance (d), and the scattering coefficient (uₛ).

$${μ}_{a} = - \frac{ln ( CT )}{d} - {μ}_{s} \qquad ( 3 )$$

Step S230 is a step of determining the type of fire or a non-fire factor.

The processor 133 performs a determination of the cause substance of the smoke particles and the presence or absence of fire based on the absorption coefficient (uₐ) and the scattering coefficient (uₛ). Specifically, the processor 133 determines the cause substance of the smoke particles by calculating the ratio of the absorption coefficient (uₐ) and the scattering coefficient (uₛ), and determines the presence or absence of fire based on the cause substance.

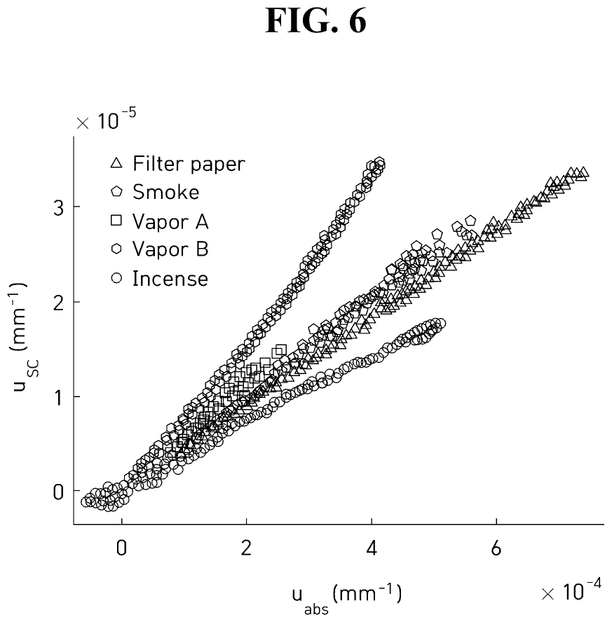

FIG. 6 is a cumulative scatter plot in which absorption coefficients and scattering coefficients according to smoke concentrations for each smoke type are indicated. That is, FIG. 6 is a cumulative scatter plot in which the absorption coefficients and the scattering coefficients are derived as the results of the measurement of various types of smoke through experiments in which concentrations of the smoke are changed in real time. A signal that is absorbed or scatted from smoke particles (including vapor) with respect to the smoking of filter paper, electronic cigarette smoke, incense, an ultrasonic humidifier (vapor A), and a heated humidifier (vapor B). The calculation of the absorption coefficient (uₐ) and the scattering coefficient (uₛ) based on the results of the measurement are illustrated in FIG. 6. As in Equation 4, the scattering coefficient (uₛ) and the absorption coefficient (uₐ) may be expressed as the product of a molecular scattering coefficient (εₛ), a molecular absorption coefficient (εₐ), and a smoke concentration (c), and is increased or decreased depending on the smoke concentration (c).

$${μ}_{s} = {ε}_{s} c , {μ}_{a} = {ε}_{a} c \qquad ( 4 )$$

The processor 133 identifies the cause substance of smoke by calculating the ratio of the molecular absorption coefficient (εₐ) and the molecular scattering coefficient (εₛ) as in Equation 5. The ratio of the molecular absorption coefficient (εₐ) and the molecular scattering coefficient (εₛ) is the same as the ratio of the absorption coefficient (uₐ) and the scattering coefficient (uₛ). That is, the processor 133 calculates the ratio of the molecular absorption coefficient (εₐ) and the molecular scattering coefficient (εₛ) by calculating the ratio of the absorption coefficient (uₐ) and the scattering coefficient (uₛ). The ratio is a value indicative of intrinsic properties of a material, and is not changed (refer to FIG. 6) although the smoke concentration (c) is changed. Accordingly, the processor 133 may estimate the cause substance based on the ratio.

$$Ratio = \frac{{μ}_{s}}{{μ}_{a}} = \frac{{ε}_{s}}{{ε}_{a}} \qquad ( 5 )$$

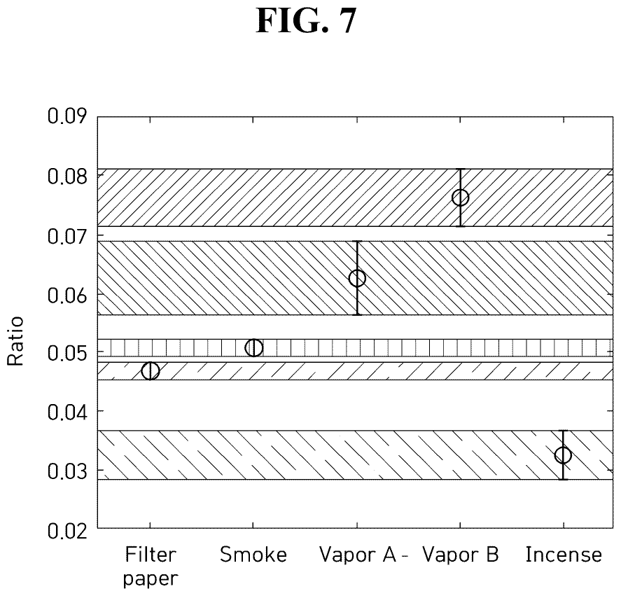

FIG. 7 is a diagram illustrating the ratio of the molecular absorption coefficient and the molecular scattering coefficient for each smoke type. FIG. 7 illustrates the ratios of material-intrinsic properties calculated from various types of smoke. In FIG. 7, it may be seen that there is no section in which the ratios of materials overlap. The ratios of material-intrinsic properties are increased as the material is white smoke and becomes close to 0 as the material is dark smoke.

The processor 133 determines a cause substance of smoke based on the ratio of the molecular absorption coefficient (εₐ) and the molecular scattering coefficient (εₛ), and determines the presence or absence of fire and the type of fire (upon fire) based on the determined cause substance. For example, if the cause substance of smoke is paper, the processor 133 determines that fire has occurred, and determines the type of fire to be “common”, among common, oil, electricity, or metal. Furthermore, for example, if the cause substance of smoke is vapor, the processor 133 determines that fire has not occurred.

Referring back to FIG. 5, step S240 is described.

Step S240 is a step of transmitting or providing notification of the results of the determination in step S230.

The processor 133 may notify the outside of the results of the determination (e.g., the presence or absence of fire, the cause substance, or the smoke concentration) through an output interface device (e.g., a display or a speaker) included in the smoke detector 100 or the air intake type smoke detection system 10.

Furthermore, the processor 133 may transmit information including the results of the calculation in step S220 and/or the results of the determination in step S230 to a user terminal through the communication device 140.

The operating method of the air intake type smoke detector has been described with reference to the flowcharts presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIG. 5, each of the steps may be further divided into additional steps or the steps may be combined into smaller steps depending on an implementation example of the present disclosure. Furthermore, some of the steps may be omitted, if necessary, and the sequence of the steps may be changed. Furthermore, the contents of FIGS. 1 to 4, although some contents are omitted, may be applied to the contents of FIG. 5. Furthermore, the contents of FIG. 5 may be applied to the contents of FIGS. 1 to 4.

Furthermore, the operating method of the air intake type smoke detector according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

Although the present disclosure has been described with reference to the preferred embodiments, those skilled in the art may understand that the present disclosure may be modified and changed in various ways without departing from the spirit and scope of the present disclosure written in the claims.

### DESCRIPTION OF REFERENCE NUMERALS

100: air intake type smoke detector
110: light-emitting unit
111: light-emitting element
112: lens
120: light-receiving unit
121: first light-receiving element (light-receiving element for light absorption measurement)
122: second light-receiving element (light-receiving element for light scattering measurement)
123: cover glass
130: signal processing unit
131: amplifier
132: analog-digital converter (ADC)
133: processor
134: memory
140: communication device

What is claimed is:

1. An operating method of an air intake type smoke detector, the operating method performed by an air intake type smoke detector comprising:
radiating light to smoke particles inhaled into air intake type smoke detector by using a light-emitting element;
obtaining a transmissive signal and a scattering signal as results of the radiation of the light to the smoke particles by using a light-receiving element;
calculating an absorption coefficient and scattering coefficient of the smoke particles based on the transmissive signal and the scattering signal;
performing a determination of a cause substance of the smoke particles and a presence or absence of fire based on the absorption coefficient and the scattering coefficient; and
notifying an outside of results of the determination through at least one means comprising a transmission of information to a user terminal, a display, and a speaker.

2. The operating method of claim 1, wherein the light-emitting element is a one-dimensional or two-dimensional light source array.

3. The operating method of claim 2, wherein the light source array comprises any one of a plurality of light sources having an identical wavelength and a plurality of light sources having different wavelengths.

4. The operating method of claim 1, wherein the light-receiving element comprises a first light-receiving element that is a light-receiving element for light absorption measurement and a second light-receiving element that is a light-receiving element for light scattering measurement.

5. The operating method of claim 1, wherein the calculating of the absorption coefficient and the scattering coefficient comprises:
calculating a collimated transmittance of the light based on the transmissive signal;
calculating a total transmittance of the light based on the transmissive signal and the scattering signal;
calculating the scattering coefficient based on the collimated transmittance, the total transmittance, and a transmission distance of the light; and
calculating the absorption coefficient based on the collimated transmittance, the transmission distance, and the scattering coefficient.

6. The method of claim 1, wherein the performing of the determination comprises:
calculating a ratio of the absorption coefficient and the scattering coefficient;
determining the cause substance based on the ratio; and
determining the presence or absence of the fire based on the cause substance.

7. An air intake type smoke detector comprising:
a light-emitting unit comprising a light-emitting element and configured to radiate light to inhaled smoke particles;
a light-receiving unit comprising a light-receiving element and configured to obtain a transmissive signal and a scattering signal as results of the radiation of the light to the smoke particles by using the light-receiving element; and
a signal processing unit comprising a processor and memory in which one or more instructions executed by the processor are stored,
wherein the one or more instructions comprise:
an instruction to calculate an absorption coefficient and scattering coefficient of the smoke particles based on the transmissive signal and the scattering signal;
an instruction to perform a determination of a cause substance of the smoke particles and a presence or absence of fire based on the absorption coefficient and the scattering coefficient; and
an instruction to notify an outside of results of the determination through at least one means including a transmission of information to a user terminal, a display, and a speaker.

8. The air intake type smoke detector of claim 7, wherein the light-emitting element is a one-dimensional or two-dimensional light source array.

9. The air intake type smoke detector of claim 8, wherein the light source array comprises any one of a plurality of light sources having an identical wavelength and a plurality of light sources having different wavelengths.

10. The air intake type smoke detector of claim 7, wherein the light-receiving element comprises a first light-receiving element that is a light-receiving element for light absorption measurement and a second light-receiving element that is a light-receiving element for light scattering measurement.

11. The air intake type smoke detector of claim 7, wherein the instruction to calculate the absorption coefficient and the scattering coefficient comprises:
an instruction to calculate a collimated transmittance of the light based on the transmissive signal;
an instruction to calculate a total transmittance of the light based on the transmissive signal and the scattering signal;
an instruction to calculate the scattering coefficient based on the collimated transmittance, the total transmittance, and a transmission distance of the light; and
an instruction to calculate the absorption coefficient based on the collimated transmittance, the transmission distance, and the scattering coefficient.

12. The air intake type smoke detector of claim 7, wherein the instruction to perform the determination comprises:
an instruction to calculate a ratio of the absorption coefficient and the scattering coefficient;
an instruction to determine the cause substance based on the ratio; and
an instruction to determine the presence or absence of the fire based on the cause substance.
